(19) United States
(12) Patent Application Publication
(10) Pub. No.: US 2005/0139120 A1
(43) Pub. Date: Jun. 30, 2005

(54) Auto care compositions with UV absorbers

(75) Inventors: Felix Muller, Velbert (DE); Patrick Winter, Essen (DE)

Correspondence Address: Leopold Presser;Scully, Scott, Murphy & Presser, 400 Garden City Plaza, Garden City, NY, 11530, US

(73) Assignee: GOLDSCHMIDT AG

(21) Appl. No.: 10/996,759

(22) Filed: Nov. 24, 2004

(30) Foreign Application Priority Data
Dec. 10, 2003 (DE) 103 57 683.5

(51) Int. Cl. C09G 1/00

(52) U.S. Cl. 106/3

(57) ABSTRACT

Paste and liquid emulsion care compositions for cleaning, caring for and paving paint and trim components of motor vehicles are provided. The compositions include, as a UV filter, from 2% to 15% by weight, based on the total weight of the composition, of zinc oxide with particle sizes in the nm range. The zinc oxide can be coated to provide a hydrophobic coating thereon.

### FIELD OF THE INVENTION

The present invention relates to paste and liquid emulsion care compositions for cleaning, caring for and preserving paint and trim components of motor vehicles. The auto care composition of the present invention comprises, as a UV filter, zinc oxide with particle sizes in the nm range. The auto care compositions protect the vehicle paint against harmful influences of UV radiation and sunlight and so durably enhance the visual appearance of a vehicle.

### BACKGROUND OF THE INVENTION

In modern-day auto care more and more value is being placed on long-lasting protection of the vehicle paint. The increasing environmental influences, the switch to water-based paint systems, the increasing average age of vehicles on the road, and the increase, observable in many markets, in the number of vehicles with light-colored, sensitive finishes (white, orange, yellow, red) are necessitating new approaches at protecting the paint of the vehicle.

Auto care normally consists of two operations:
1. Auto washing, in which adhered dirt is removed by mechanical treatment (brushes) and surface-active agents (auto shampoo). After the wash, the run-off aid permits rapid drying and a gloss effect is achieved through attachment of cationic surfactants.
2. Auto polishing, in which abrasive substances clean the vehicle's paint more thoroughly and the topmost layer, which has suffered attack, is removed In order to maintain the gloss of the vehicle paint, which is intensified by the polished paint surface, additions to auto polishes include amino-modified siloxane, for achieving high detergent resistance, and silicone oil, as a gloss agent. See, for example, U.S. Pat. No. 5,968,238.

These measures, however, are unsuitable for protecting paint surfaces, especially “fresh” paint surfaces exposed after polishing with abrasive constituents, against the harmful effect of UV radiation.

The patent literature is a testament to the attempts made in this respect to use, in particular, UV-absorbing substances, which have been typically used in the cosmetics sector in sunscreen formulations, in auto polish as well.

EP-A 373 838 teaches the use of 1,3-diketocyclohexane compounds as U absorbers in auto polish

U.S. Pat. No. 4,889,947 describes naphihalenylidenes suitable for use in sunscreen formulations for human skin, but also mentions the possibility of other applications, such as an ingredient for an auto polish

JP-A-57-182371 describes salicylates which, in addition to the UV protection, are also said to have fungicidal properties.

A feature common to all organic UV filter substances, however, is that they cannot be employed without objection, instead, on certain paints, UV-catalyzed reactions, or reactions sensitized by photoelectron transfer, may occur with the pigments present in the paint, resulting in the possibility of damage to the auto's paint UV-active organic compounds in particular, besides the desired quenching effect, may also trigger a multiplicity of side reactions, particularly in the case of especially severe or prolonged exposure.

Consequently the use of these products, which are relatively unobjectionable for application to human skin, as shown in numerous studies, is not appropriate in an application such as that of auto care.

The attempt to use inorganic pigments acceptable to the consumer as UV filter substances has not to date resulted in success.

Zinc oxide in macroscopic particle size has already been used in auto polishes as an abrasive, as taught by BE 714 006. In the form described therein, however, it is unsuitable as a UV protection additive.

The titanium dioxide (anatase, rutile) used with preference in cosmetic sunscreen formulations, with mean particle sizes in the nm range, shows no effect in auto care compositions, either alone or in combination with the organic UV filters customary in such formulations.

In view of the above mentioned problems with prior art auto care compositions, there is a need to develop auto care compositions, suitable to the consumer, for cleaning, caring for and preserving paint and trim components of motor vehicles, especially for auto polishes, which at the same time produce a high light protection effect on the auto paint.

### SUMMARY OF THE INVENTION

The present invention provides paste and liquid emulsion auto care compositions that are capable of overcoming the problems mentioned above. Specifically, the above problems with prior art auto care compositions has been solved through the use of nanostructured zinc oxide, ZnO having mean particle sizes in the nm range.

The present invention accordingly provides paste and liquid emulsion care compositions for cleaning, caring for and preserving paint and trim components of motor vehicles, wherein the compositions comprise, as a UV filter, from 2% to 15% by weight, based on the total weight of the composition, of zinc oxide having particle sizes in the nm range.

Nanostructured zinc oxide having a mean particle size of less than 400 nm, in particular less than 300 nm, surprisingly meets the requirement of ensuring UV protection for paint surfaces without at the same time catalyzing photochemical side reactions. Other nanostructured pigments tested, which meet the profile of requirements, such as titanium dioxide grades, did not show any effect in accordance with the present invention, as described below.

### BRIEF DESCRIPTION OF THE DRAWINGS

FIG. 1 is a plot of b* value vs. months of UV radiation for a reference sample, a polish only sample and a sample that was polished with a polish including ZnO in accordance with the present invention and as set forth and described in Example 1.

FIG. 2 is a plot of b* value vs. days of V radiation for a reference sample, a polish only sample and a sample that was polished with a polish including TiO₂ and as set forth and described in Example 2.

FIG. 3 is a plot of b* value vs. days of UV radiation for a reference sample, a polish only sample and a sample that was polished with a polish including coated ZnO in accordance with the present invention and as set forth and descried in Example 3.

FIG. 4 is a plot of b* value vs. days of UV radiation for a polish only sample and a sample that was polished with a polish including coated ZnO in accordance with the present invention and as set forth and described in Example 4.

FIG. 5 is a plot of b* value vs. dayss of UV radiation for a reference sample, a polish only sample, a sample that was polished with a polish including coated ZnO in accordance with the present invention and as set forth and described in Example 5.

FIG. 6 is a plot of b* value vs. days of UV radiation for a reference sample, a polish only sample, a sample that was polished with a polish including coated ZnO in accordance with the present invention and as set forth and described in Example 6.

### DETAILED DESCRIPTION OF THE INVENTION

As stated above, the present invention provides auto care compositions, which are in the form of a paste or liquid emulsion, that include, as a UV filter, from 2% to 15% by weight, based on the total weight of the composition of nanostructured ZnO. The term ‘nanostructured’ is used herein to denote that the ZnO has mean particles sizes that are within the nm range.

The preparation of the nanostructured zinc oxide that can be employed in the present invention is described in DE-A-102 12 680, as are methods of monitoring the median of the particle size. The entire content of DE-A-102 12 680 is thus incorporated herein by reference.

These zinc oxides are used in the present invention in concentrations from 2% to 15% by weight, preferably from 5% to 7% by weight, based on the total weight of the care composition.

In one embodiment of the present invention, the zinc oxide employed has mean particle sizes of ≦400, in particular ≦300 nm and a BET surface area of from 2 to 100 m². In another embodiment of the present invention, the zinc oxide employed has mean particle sizes of ≦400, in particular ≦300 nm and a BET surface area of from 5 to 50 m². In yet another embodiment of the present invention, the zinc oxide used has mean particle sizes of ≦400, in particular ≦300 nm and a BET surface area of from 10 to 30 m². In still yet another embodiment of the present invention, the zinc oxide employed has mean particle sizes of ≦400, in particular ≦300 nm and a BET surface area of from 15 to 25 m².

One preferred embodiment of the present invention is the use of zinc oxide which is coated hydrophobically by means of a particular coating technique.

Suitable coating materials are the compounds known for this purpose in the prior art, but especially organically modified silanes such as octyltrimethoxysilane, which produce a hydrophobic film around the nanoparticles.

As care compositions, it is possible in accordance with the present invention to use any commercially customary water-in-oil, W/O or oil-in-water, O/W based emulsions, especially emulsions of silicone oils, aminosiloxanes or other silicone derivatives, which may additionally comprise abrasives such as aluminum oxides or silicates and, if desired, other auxiliaries, preservatives, emulsifiers and consistency modifiers.

The zinc oxide can be used as a powder from production directly or in dispersion form. In the latter case, the zinc oxide can be in dispersion in water, organic solvents or alternatively—in hydrophobicized form—in silicone oils and organically modified derivatives thereof.

Test Methods

1. Dispersing Method:

The dispersions set out below in the examples were prepared in the laboratory using a H-drive stirrer of type 4REB/L from Heynau, Munich, Germany. A disperser disk with a diameter of 4 cm was used to disperse the mixtures for 5 minutes. The stirring speed was 2500 rpm.

2. Surface Polishing:

The painted surfaces were polished by the conventional method, applying commercially customary polishes or waxes. To ensure that the same amount of polish was applied to the paint in each case, exactly 1.0 g of a polish was applied over an area of 4.5×7.5 cm. To distribute the polish uniformly over this area, a disposable cosmetic tissue measuring 20×20 cm was used, folded to a quarter of its size. After the applied and uniformly distributed polish had dried, the polished paint was buffed with a commercially customary polishing rag for about 30 seconds, without substantial pressure.

3. UV Irradiation:

In order to simulate the yellowing effect of a paint, a manual UV lamp of the type NU-15 KL was used, with two UV tubes of a wavelength of 254 nm and 366 nm, with an output each of 15 watts.

4. Determination of Color Value:

The color values were measured using an X-Rite SP68 spectrophotometer.

The measurement method was in accordance with the CIELAB system. In this system, also called CIE L*a*b*, all shades of equal brightness are located on a flat, circular plane, on which the a* and b* axes are located. Positive a* values are reddish, negative a* values greenish, positive b* values yellowish and negative b* values bluish Situated around the equator of the color disk are the pure shades of high saturation. Toward the inside the saturation decreases, and in the center it is zero (achromatic, gray).

To ascertain a yellowing effect the b* value of each painted surface was determined. This was done by determining the b* value three times each at three points on a surface. The resulting values were averaged to give a representative value, which is quoted in the examples.

The following examples are provided to illustrate some advantages of the inventive auto care compositions which include, as a UV filter, from 2% to 15% of ZnO having mean particles sizes that are within the nm range.

### EXAMPLE 1

1.0 g of nanostructured uncoated zinc oxide (PH 10520 ZnO in accordance with DE-A-102 12 680) having a specific surface area of 19 m²/g were dispersed by the method described above into 49.0 g of a commercially customary Polish & Wax Auto polish (solvent-flee, water-based).

A metal panel painted with red auto paint (DeBeer, Art. No.9952/1)+clearcoat H5420 and curative HS 420 (DeBeer) in a 2:1 ratio was polished over half of its area with this dispersion in accordance with the method described above. The other half was treated with the same polish, but without zinc oxide added.

These surfaces were irradiated with UV light (254 nm/366 nm) over a period of four months.

The blank value was that of the same paint, but without UV treatment, which hence serves as a reference.

The results of this test are shown in FIG. 1 which also includes a table indicating the b* value for each sample at 1 month, 2 months and 4 months. The blank value (i.e., reference sample) for the paint not exposed to UV radiation, showed the undistorted shade. The greater the numerical deviation of the other radiation-exposed samples, the greater the yellowing effect As can be seen, the inventive formulation (polish+ZnO) had a marked protective effect as compared with the polish without the inventive addition (polish only).

### EXAMPLE 2

(Comparative Example):

2.5 g of titanium dioxide were dispersed into 47.5 g of a commercially customary Polish & Wax Auto polish (solvent-free, water-based). These experiments were carried out using a metal panel painted with a white paint based on Siikoftal® ED (Tego Chemie Service TCS). This paint is UV-sensitive and shortens the time of UV radiation required to achieve a yellowing effect to a few days. This panel was polished over half of its area with this dispersion, in accordance with the method described above. The other half was treated with the same polish, but without titanium dioxide added.

Over a period of 7 days this surface was irradiated with UV light (254 nm/366 nm).

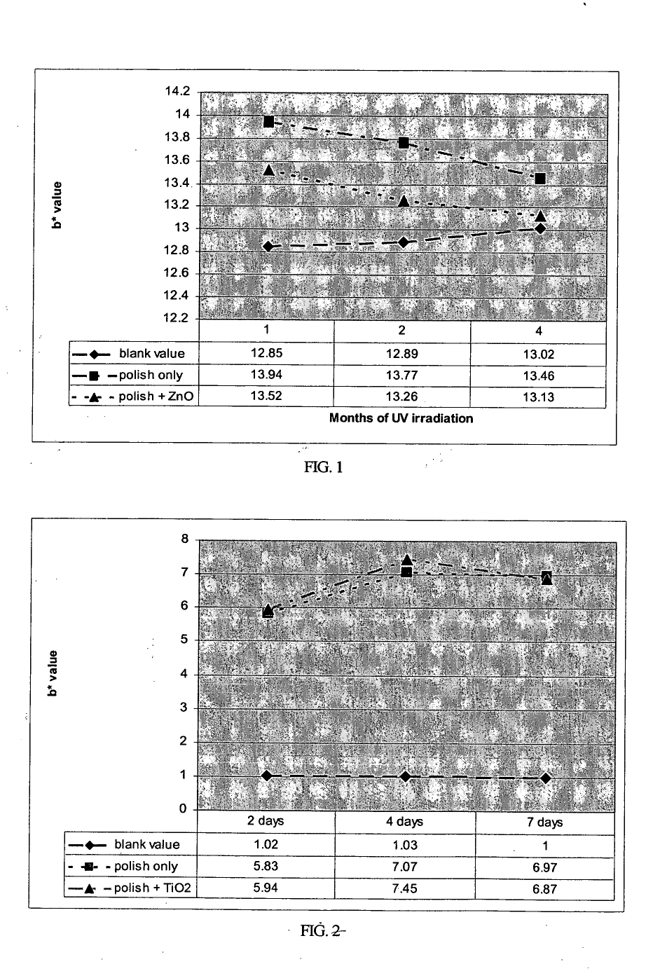

The results of this test are shown in FIG. 2 which also includes a table indicating the b* value for each sample at 2 days,4 days and 7 days. As can be seen, the use of titanium dioxide, which is used for sunscreen formulations in cosmetics, had no positive effect in the present field. In contrast to the ZnO used in accordance with the invention, indeed, it had a negative effect: the degree of yellowing of the paint was greater (polish+TiO₂) than in the case of the commercially customary polish (polish only).

### EXAMPLE 3

2.5 g of ZnO hydrophobicized with octyltrimethoxysilane (VT 2665) having a surface area of 19±1 m²/g (proposed; Degussa, unpublished EP Appl. No.03018678.7) were dispersed into 47.5 g of Sonax Polish & Wax Auto polish (solvent-free, water-based). A metal panel painted with UV-sensitive white paint based on Silikoftal ED was polished with this dispersion over half of its area in accordance with the method described above. The other half was treated with the same polish, but without zinc oxide added.

Over a period of 7 days these surfaces were irradiated with UV light (254 nm/366 nm).

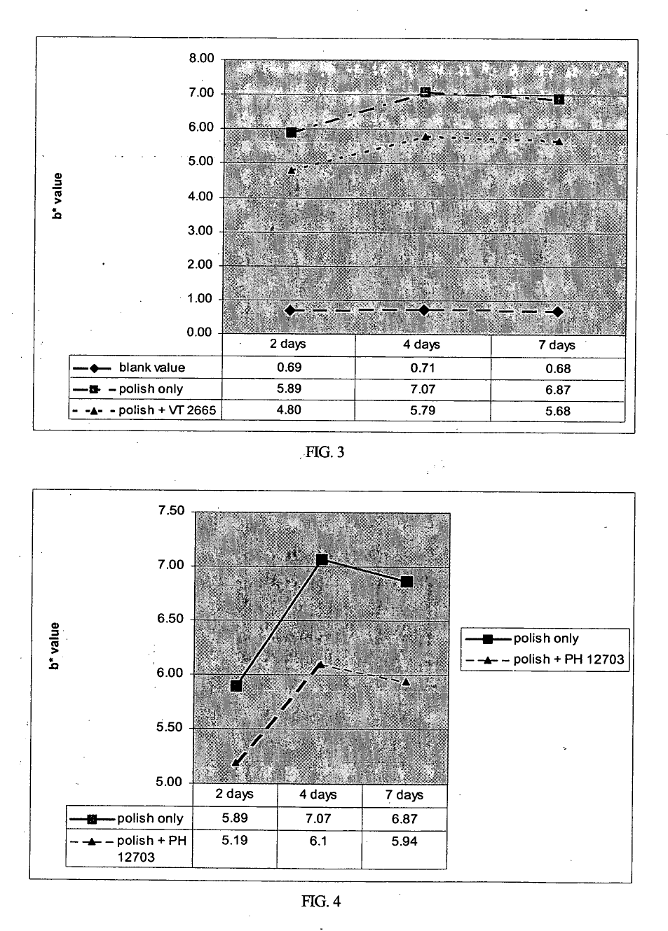

The results of this test are shown in FIG. 3 which also includes a table indicating the b* value for each sample at 2 days, 4 days and 7 days. The values found showed that with the zinc oxide used here (VT 2665) the yellowing effect on a paint caused by UV irradiation is reduced by 17%.

### EXAMPLE 4

2.5 g of ZnO hydrophobicized with octyltrimethoxysilane having a surface area of 19±1 m²/g (PH 12703; Degussa, unpublished EP Appl. No. 03018678.7) were dispersed into 47.5 g of Sonax Polish & Wax Auto polish (solvent-free, water-based). A metal panel painted with UV-sensitive white paint based on Silikoftal® ED was polished with this dispersion over half of its area in accordance with the method described above. The other half was treated with the same polish but without zinc oxide added.

Over a period of 7 days these surfaces were irradiated with U light (254 nm/366 nm).

The results of this test are shown in FIG. 4 which also includes a table indicating the b* value for each sample at 2 days, 4 days and 7 days. The values found showed that with the zinc oxide used here (PH 12703) the yellowing effect on a paint caused by UV irradiation was reduced by around 14%.

### EXAMPLE 5

These experiments were carried out using an in-house formulation for a detergent-resistant auto polish:

Formula:

| | |
|---|---|
| TAGAT ® S ethoxylated fatty acid esters | 3.6% |
| Water, demineralized | 10.0% |
| Lunacerin W 60 | 2.0% |
| TEGIN ® M glyceryl monodistearate | 1.8% |
| TEGILOXAN 350 silicone oil | 5.0% |
| TEGO POLISH | |
| ADDITIVE C 3191 aminosiloxane | 3.0% |
| Water, demineralized | 70.4% |
| Sodium chloride | 0.2% |

Mixture 1: 2.5 g of ZnO hydrophobicized with octyltrimethoxysilane and having a surface area of 19±1 m²/g (VT 2665) were dispersed into 47.5 g of this polish A metal panel painted with UV-sensitive white paint based on Silikoftal® ED was polished over half of its area with this dispersion in accordance with the method described above.

Mixture 2: 2.5 g of ZnO hydrophobicized with octyltrimethoxysilane and having a surface area of 19±1 m²/g (PH 12703) were dispersed into 47.5 g of this polish The other half of the surface described above was polished with this dispersion.

As a reference the same paint was used, likewise polished with the polish described above, but without zinc oxide added.

Over a period of 7 days these surfaces were irradiated with UV light (254 nm/366 nm).

The results of this test are shown in FIG. 5 which also includes a table indicating the b* value for each sample at 2 days, 4 days and 7 days. Here again the marked protective effect of the added ZnO was apparent

### EXAMPLE 6

This example was carried out using as auto polish Sonax Xtreme Polish & Wax 3.

Mixture 1: 2.5 g of hydrophobicized ZnO having a surface area of 19±1 m²/g (VT 2665) were dispersed into 47.5 g of this polish A metal panel painted with UV-sensitive white paint based on Silikoftal ED was polished over half of its area with this dispersion in accordance with the method described above.

Mixture 2: 2.5 g of hydrophobicized ZnO having a surface area of 19±1 m²/g (PH 12703) were dispersed into 47.5 g of this polish. The other half of the surface described above was polished with this dispersion.

As a reference the same paint was used, likewise polished with the polish described above, but without zinc oxide added.

Over a period of 7 days these surfaces were irradiated with UV light (254 nm/366 nm).

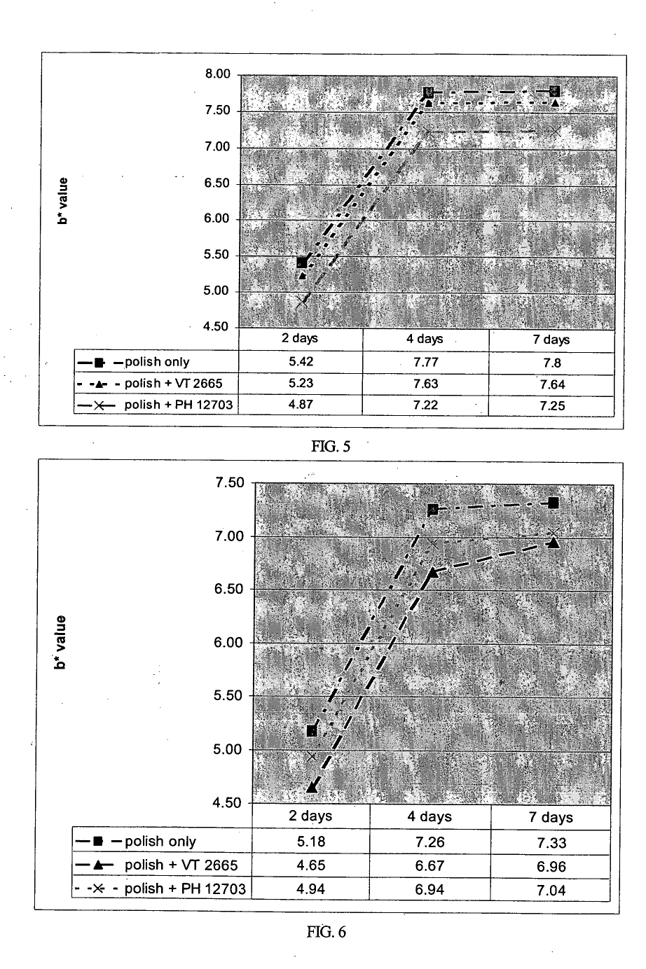

The results of this test are shown in FIG. 6 which also includes a table indicating the b* value for each sample at 2 days, 4 days and 7 days. Here again the marked protective effect of the added ZnO was apparent.

While the present present invention has been particularly shown and described with respect to preferred embodiments thereof, it will be understood by those skilled in the art that the foregoing and other changes in forms and details may be made without departing from the spirit and scope of the present invention. It is therefore intended that the present invention not be limited to the exact forms and details described and illustrated, but fall within the scope and spirit of the appended claims.

1. A paste or liquid emulsion care composition for cleaning, caring for and preserving paint and trim components of motor vehicles comprising, as a UV filter, from 2% to 15% by weight, based on the total weight of the composition, of zinc oxide, said zinc oxide having particle sizes in the nm range.

2. The composition as claimed in claim 1, wherein the zinc oxide has mean particle sizes of ≦400 and a BET surface area of from 2 to 100 m².

3 The composition as claimed in claim 2, wherein said mean particle sizes are ≦300 nm.

4. The composition as claimed in claim 1, wherein the zinc oxide has mean particle sizes of ≦400 and a BET surface area of from 5 to 50 m².

5 The composition as claimed in claim 4, wherein said mean particle sizes are ≦300 nm.

6. The composition as claimed in claim 1, wherein the zinc oxide has mean particle sizes of ≦400 and a BET surface area of from 10 to 30 m².

7. The composition as claimed in claim 6, wherein said mean particle sizes are ≦300 nm.

8. The composition as claimed in claim 1, wherein the zinc oxide has mean particle sizes of ≦400 and a BET surface area of from 15 to 25 m².

9 The composition as claimed in claim 8, wherein said mean particle sizes are ≦300 nm.

10. The composition as claimed in claim 1, wherein said zinc oxide includes a hydrophobic coating.

11. A method for cleaning, caring for and preserving paint and trim components of motor vehicles comprising:
applying a paste or liquid emulsion care composition including from 2% to 15% of a UV filter comprising nanostrutured zinc oxide to said motor vehicle.

12. The method as claimed in claim 11, wherein the zinc oxide has mean particle sizes of ≦400 and a BET surface area of from 2 to 100 m².

13 The method as claimed in claim 12, wherein said mean particle sizes are ≦300 nm.

14. The method as claimed in claim 11, wherein the zinc oxide has mean particle sizes of ≦400 and a BET surface area of from 5 to 50 m².

15 The method as claimed in claim 14, wherein said mean particle sizes are ≦300 nm.

16. The method as claimed in claim 11, wherein the zinc oxide has mean particle sizes of ≦400 and a BET surface area of from 10 to 30 m².

17. The method as claimed in claim 16, wherein said mean particle sizes are ≦300 nm.

18. The method as claimed in claim 11, wherein the zinc oxide has mean particle sizes of ≦400 and a BET surface area of from 15 to 25 m².

19 The method as claimed in claim 18, wherein said mean particle sizes are ≦300 nm.

20. The composition as claimed in claim 11, wherein said zinc oxide includes a hydrophobic coating.
